(19) United States
(12) Patent Application Publication
(10) Pub. No.: US 2015/0081175 A1
(43) Pub. Date: Mar. 19, 2015

(54) VEHICLE USER PREFERENCE SYSTEM AND METHOD OF USE THEREOF

(71) Applicant: Nvidia Corporation, Santa Clara, CA (US)

(72) Inventor: Andrew Fear, Austin, TX (US)

(73) Assignee: Nvidia Corporation, Santa Clara, CA (US)

(21) Appl. No.: 14/029,926

(22) Filed: Sep. 18, 2013

(51) Int. Cl. B60H 1/00; H04W 4/00; B60N 2/02

(52) U.S. Cl. CPC B60H 1/00642; B60N 2/0244; H04W 4/008
USPC 701/49; 701/36

(57) ABSTRACT

A vehicle user preference system and a method of applying user preferences. One embodiment of the vehicle user preference system includes: (1) a memory configured to store a user preference data structure, according to which user preferences are stored, (2) a Bluetooth communication interface operable to gain access to a device ID profile (DIP) identifying a mobile device communicably coupled thereto and associated with the user preference data structure, and (3) a processor communicably coupled to the memory and the Bluetooth communication interface, and configured to employ the DIP in gaining access to the user preference data structure, and cause the user preferences to be applied to vehicle subsystems.

### TECHNICAL FIELD

This application is directed, in general, to vehicle user preferences and, more specifically, to storing and retrieving vehicle user preferences.

### BACKGROUND

Automobiles are becoming increasingly advanced. The latest models have more integrated and computer based systems. Even the most fundamental systems are advancing into highly automated electronic controls. Power seats and mirrors were once revolutionary options; then there were 6-way, 8-way, and 10-way power seats, and mirrors that auto-dim, melt ice, and auto-fold. Interior comfort has been a significant focus of auto manufacturers. Aside from spacious cabins and high-quality materials, this effort has spawned multi-zone climate control, controlled lighting, and major steps toward a fully integrated central computer that can check tire pressure as easily as tuning a radio. These central computers are sometimes referred to as “info-tainment” systems. Additionally, most auto manufacturers have adopted systems to integrate mobile devices into the vehicle, melding two of the most ubiquitous possessions one can own. Many smart phones can connect to the vehicle by a wired or wireless connection, providing basic cellular phone service and audio playback through the vehicle's audio system.

### SUMMARY

One aspect provides a vehicle user preference system. In one embodiment, the system includes: (1) a memory configured to store a user preference data structure, according to which user preferences are stored, (2) a Bluetooth communication interface operable to gain access to a device ID profile (DIP) identifying a mobile device communicably coupled thereto and associated with the user preference data structure, and (3) a processor communicably coupled to the memory and the Bluetooth communication interface, and configured to employ the DIP in gaining access to the user preference data structure, and cause the user preferences to be applied to vehicle subsystems.

Another aspect provides a method of applying user preferences to a vehicle. In one embodiment, the method includes: (1) receiving a DIP indicative that a particular user is present, (2) employing the DIP to gain access to user preferences associated with the particular user, and (3) causing the user preferences to be applied to vehicle subsystems.

Yet another aspect provides an automobile computer system. In one embodiment, the system includes: (1) a memory configured to store a plurality of user preference data structures, according to which respective user preferences for a plurality of users are stored, (2) a Bluetooth subsystem operable to detect and pair with a mobile device having a DIP associated with a particular user preference data structure of the plurality of user preference data structures, (3) a processor communicably coupled to the Bluetooth subsystem and the memory, and operable to gain access to and employ the DIP to gain access to the particular user preference data structure, and (4) a subsystem interface communicably coupled to the processor and configured to apply the respective user preferences contained in the particular user preference data structure to a plurality of vehicle subsystems in an automobile.

### BRIEF DESCRIPTION

Reference is now made to the following descriptions taken in conjunction with the accompanying drawings, in which:

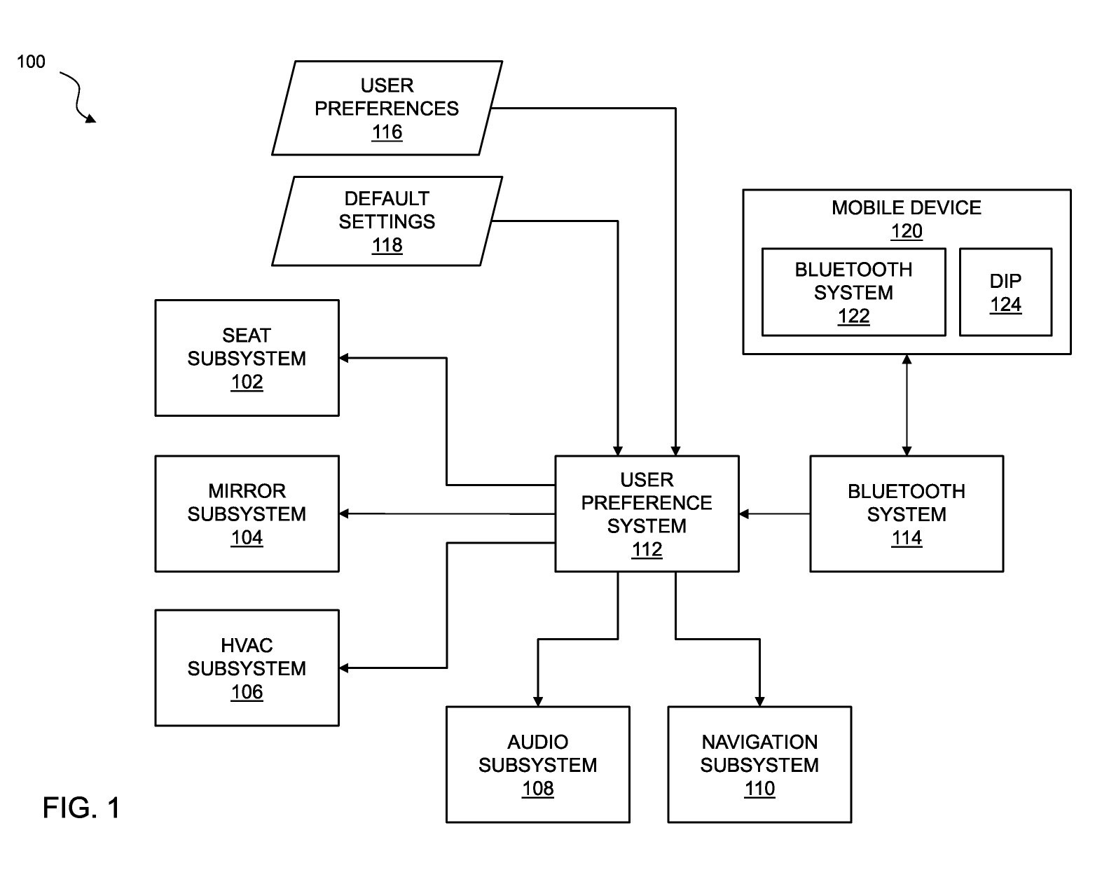

FIG. 1 is a block diagram of one embodiment of a automobile computer system;

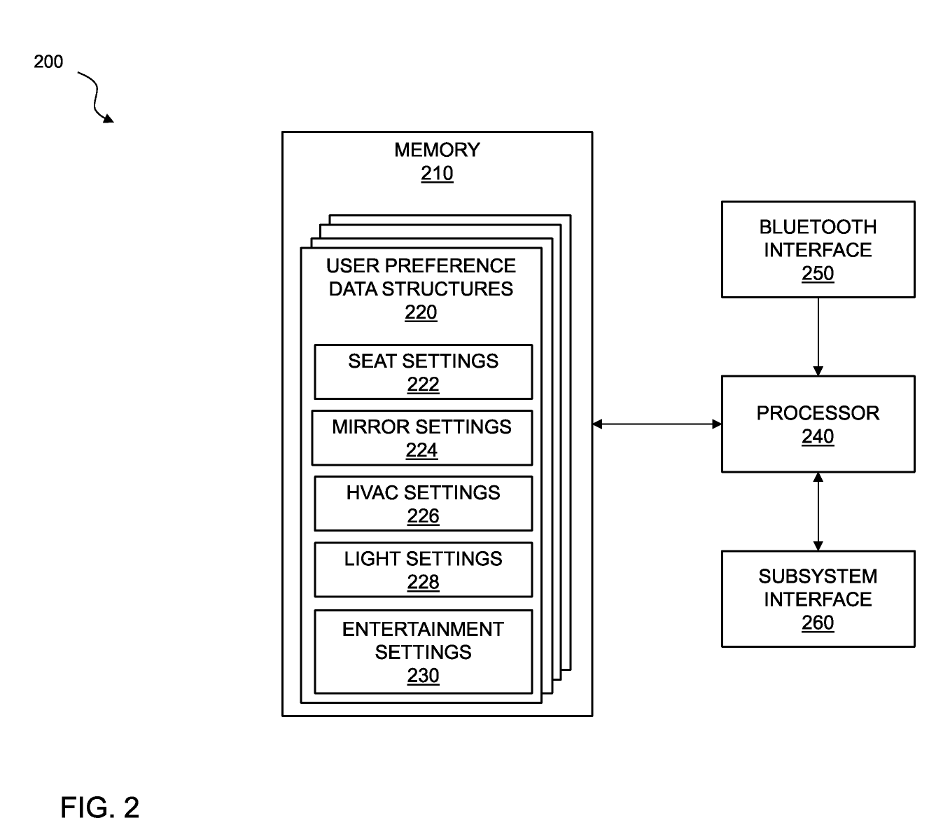

FIG. 2 is a block diagram of one embodiment of a user preference system; and

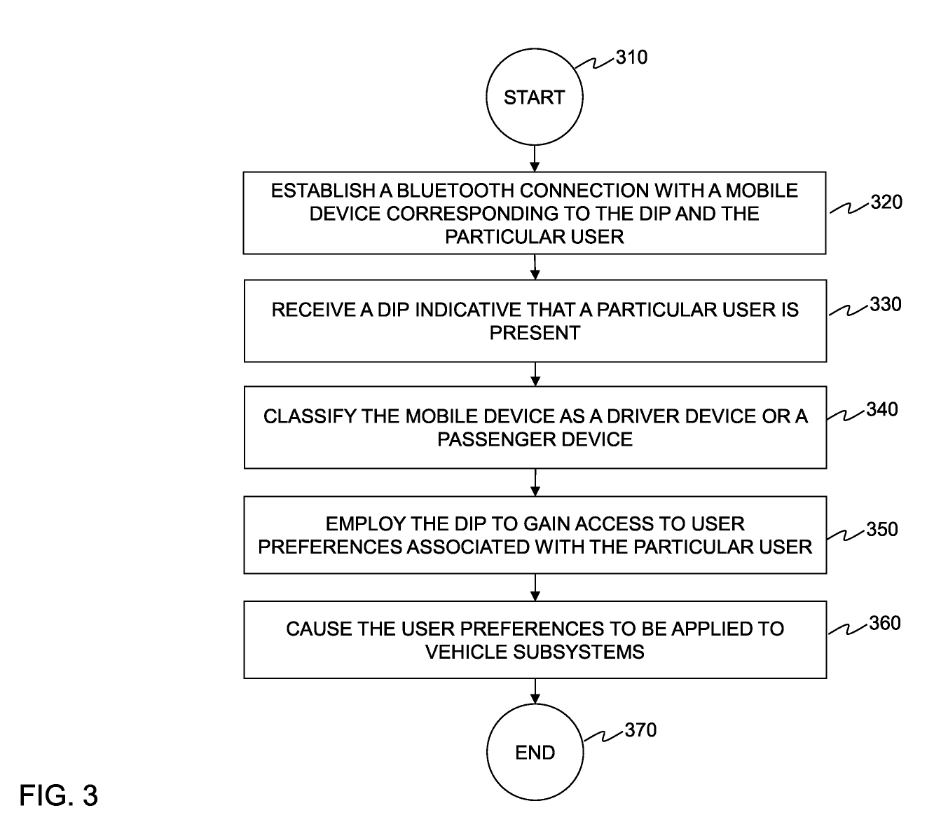

FIG. 3 is a flow diagram of one embodiment of a method of applying user preferences to a vehicle.

### DETAILED DESCRIPTION

With the addition of advanced features to automobiles comes the desire and sometimes the need to customize vehicle subsystems. Customization becomes even more important when additional drivers and passengers are considered. One user may require a drastically different seat position than another. Likewise, mirror positions vary widely among drivers. In certain vehicles, drivers and passengers alike are users of these customizable subsystems. Certain passengers may prefer a cooler climate zone, while others prefer warmer.

Customization issues and, more specifically, user preferences are addressed in some fashion by most auto manufacturers. A common approach is to place a button in the vehicle that, when pressed, causes user preferences to be applied, such as seat and mirror positions. This bit of automation significantly reduces the time necessary to get a vehicle moving and eliminates an inconvenient, but critical customization step. It is realized herein that this bit of automation can be extrapolated into virtually any vehicle subsystem, particularly those that interface with the driver and passengers, or “users.” Vehicle subsystems that could benefit from automated application of user preferences include: seats, mirrors, lighting, navigation systems, phone systems, audio systems, video systems, heating, ventilation and air conditioning (HVAC) systems, and others.

It is realized herein that user preferences can be stored, recalled, and applied based on the presence of a mobile device that can connect to the vehicle. The most common protocol for wirelessly connecting a mobile device to a vehicle is Bluetooth. Every Bluetooth enabled mobile device has a unique identifier within a device ID profile (DIP). When a Bluetooth connection is established, the vehicle can recognize a particular mobile device based on its DIP and, it is realized herein that, therefore can recognize a particular user associated with the particular mobile device. Generally, for this recognition to occur, the vehicle's Bluetooth system and the particular mobile device must be “paired.” All future connections between the vehicle and the particular mobile device are established based on that pairing.

It is further realized herein that a user preference system that has access to the DIP for the mobile device can use the DIP to store subsystem settings in a user preference data structure in memory. Additionally, it is realized herein that, the user preference data structure can be retrieved from memory using the same DIP. The user preference system can then cause the user preferences to be applied to the variety of vehicle subsystems in the vehicle.

It is also realized herein that, depending on the vehicle subsystem, user preferences may be applied directly by the user preference system, or possibly through another vehicle computer or subsystem interface. For example, certain basic systems such as seats and mirrors are driven by motors that most often cannot be controlled by a lone signal from the user preference system. In those cases, it may be necessary for the user preference system to transmit seat and mirror settings through a subsystem interface that can power the appropriate motors. In other subsystems, the user preference system, Bluetooth system, and certain vehicle subsystems may be tightly integrated, greatly simplifying the application of user preferences to the certain vehicle subsystems. For example, an audio subsystem that provides for storage of “favorites” and volume settings can easily receive those settings from an integrated user preference system.

It is realized herein that the application of user preferences is desirably carried out before a user enters the vehicle. It is realized herein that the process of connecting to a mobile device, recalling user preferences, and applying user preferences can be initiated upon a variety of events, including a user's proximity to the vehicle, unlocking the vehicle, entering the vehicle, powering on the vehicle, and others. The precise event to initiate the process likely varies among auto manufacturers and applicable vehicle safety standards.

It is also realized herein that several mobile devices can be paired and present in the vehicle at a given time. In those cases, it is important to reconcile which mobile device is associated with which user. Mobile device A may belong to a driver, and mobile devices B, C, and D may belong to passengers. A driver's settings are more expansive than basic climate and comfort settings for passengers. It is realized herein that the Bluetooth standard provides certain pieces of data the user preference system can utilize to distinguish a driver's mobile device from a passenger's. For example, the Bluetooth standard provides for gaining access to signal strength or range between antennas, which can be resolved to identify a driver's mobile device. Once identified, the DIP for the driver's mobile device can be used by the user preference system to recall and apply the appropriate subsystem settings based on the driver's user preferences for the relevant subsystems.

FIG. 1 is a block diagram of one embodiment of an automobile computer system, system 100. System 100 includes various vehicle subsystems: a seat subsystem 102, a mirror subsystem 104, an HVAC subsystem 106, an audio subsystem 108, and a navigation subsystem 110. System 100 also includes a user preference system 112 communicably coupled to a Bluetooth system 114, which is operable to connect to a mobile device 120.

Mobile device 120 includes a Bluetooth system 122 and a DIP 124. DIP 124 contains an identifier that is unique to mobile device 120. Bluetooth system 122 allows mobile device 120 and Bluetooth system 114 to pair and occasionally establish Bluetooth connections. In alternate embodiments, mobile device 120 connects to the vehicle by a wired connection, such as universal serial bus (USB). In other embodiments, mobile device 120 connects to the vehicle by some other wireless connection, such as basic radio communication, cellular connection, or WiFi, among others.

User preference system 112 and Bluetooth system 114 are communicably coupled, meaning data and signals can pass between them according to some interface. The interface may be a serial data bus, parallel data bus, or some other electrical interface.

Seat subsystem 102 is a power seat system having at least one electronically controlled dimension, such as forward/aft position, height, recline, lumbar, and others. A user preference directed to seat subsystem 102 includes settings for the controlled dimension. Similarly, mirror subsystem 104 includes at least one mirror having at least one electronically controlled dimension. Typically, mirror subsystem 104 would include a mirror that can pitch about two axes. A user preference directed to mirror subsystem 104 includes a deflection setting for the controlled dimensions.

HVAC subsystem 106 is responsible for maintaining a comfortable climate inside the cabin. In certain embodiments, HVAC subsystem 106 includes multiple climate zones, such as a driver zone, passenger zone, and a rear passenger zone. Each zone may be controlled independently. Some embodiments provide for a temperature set point for HVAC subsystem 106 to maintain. Alternate embodiments operate by a combination of a temperature setting and a blower setting. Other embodiments can include damper settings or humidity control. User preferences directed to HVAC subsystem 106 may include any of these settings mentioned above, among others.

Audio subsystem 108 includes typical vehicle entertainment components, such as an AM/FM radio, compact disc, and satellite radio. Certain embodiments may also include an interface for a portable playback device, such as an MP3 player or iPod®, or an internet radio service, such as Pandora®. User preferences directed at audio subsystem 108 may include volume, favorite stations, shuffle settings, equalizer settings, fade and balance settings, or speed adjusted volume, among others.

Navigation subsystem 110 includes a map display and, in certain embodiments, voice based directions. In alternate embodiments, navigation subsystem 110 can also convey local information, such as weather, nearby retail outlets, gas stations, airports, and other local interests. User preferences directed at navigation subsystem 110 can include display settings such as color and contrast, zoom, orientation, frame of reference, visible features, and many other features.

User preference system 112 is operable to gain access to DIP 124 through Bluetooth system 114 and to use DIP 124 to gain access to user preferences 116. User preferences 116 are generally stored in memory local to the vehicle. The same memory may also store default settings 118 for the various vehicle subsystems. For example, a default volume level may be stored to prevent unexpected outbursts for unrecognized users. Once user preference system 112 gains access to user preferences 116, user preference system 112 must distribute subsystem settings based on user preferences 116 to the various vehicle subsystems. Each vehicle subsystem generally has a unique subsystem interface, although certain subsystems may be highly integrated with user preference system 112, such as audio subsystem 108 and navigation subsystem 110. User settings generated based on user preferences 116 are then transmitted toward the appropriate vehicle subsystem where they are applied.

FIG. 2 is a block diagram of a user preference system 200. User preference system 200 includes a memory 210, a Bluetooth interface 250, a subsystem interface 260, and a processor 240. Processor 240 is communicably coupled to Bluetooth interface 250, subsystem interface 260, and memory 210. Processor 240 and Bluetooth interface 250 are coupled by a data bus through which processor 240 can retrieve DIP data for a paired mobile device. Bluetooth interface 250 is an interface layer between user preference system 200 and an external Bluetooth system that generally carries out Bluetooth communications.

Processor 240 and memory 210 are coupled by another data bus dedicated for gaining access to memory 210 and other memory devices that may be attached. In certain embodiments, processor 240 is coupled to a single data bus for gaining access to memory 210 and Bluetooth interface 250. Processor 240 can read and write to memory 210.

Memory 210 is configured to store user preference data structures 220. Each user preference data structure includes memory blocks for seat settings 222, mirror settings 224, HVAC settings 226, light settings 228, and entertainment settings 230. In certain embodiments not all memory blocks are utilized, as some vehicles may not include vehicle subsystems that support customizable subsystem settings. For example, not all vehicles have a memory-HVAC system. User preference data structures 220 are stored in memory 210 according to a unique identifier that correlates to a mobile device and its Bluetooth DIP. The DIP operates to identify a particular user of the vehicle and is used by processor 240 to gain access to the associated user preference data structure.

Processor 240 and subsystem 260 are coupled by an electrical interface. In certain embodiments, processor 240 generates and transmits analog commands through subsystem interface 260 to a particular vehicle subsystem to which a setting is to be applied. In other embodiments, utilizing a more sophisticated electrical interface, processor 240 generates and transmits a digital command through subsystem interface 260 and is received by a particular vehicle subsystem.

FIG. 3 is a flow diagram of one embodiment of a method of applying user preferences to a vehicle. The method begins in a start step 310. In a connection step 320 a Bluetooth connection is established between a vehicle's Bluetooth system and a mobile device. The mobile device corresponds to a DIP and is associated with a particular user. The DIP is received in a recognition step 330. Receipt of the DIP indicates the particular user is present. In a classification step 340, the mobile device is classified as either a driver device or a passenger device. If classified as a passenger device, certain user preferences would not be applied, such as driver seat positions and mirror positions. The DIP is employed in a read step 350 where access is had to a memory storing user preferences associated with the particular user. Once the user preferences are recalled, they are caused to be applied to the appropriate vehicle subsystems in an application step 360. Causing the user preferences to be applied can include generating and transmitting direct commands to a vehicle subsystem to apply a user setting. In alternate embodiments, user settings based on the user preferences are formed into a message that is translated into commands by an intermediate interface. The method then ends in an end step 370.

Those skilled in the art to which this application relates will appreciate that other and further additions, deletions, substitutions and modifications may be made to the described embodiments.

What is claimed is:

1. A vehicle user preference system, comprising:
a memory configured to store a user preference data structure, according to which user preferences are stored;
a communication interface operable to gain access to a device ID profile (DIP) identifying a mobile device communicably coupled thereto and associated with said user preference data structure; and
a processor communicably coupled to said memory and said communication interface, and configured to employ said DIP in gaining access to said user preference data structure, and cause said user preferences to be applied to vehicle subsystems.

2. The vehicle user preference system as recited in claim 1 wherein said vehicle subsystems include a vehicle heating, ventilation, and air-conditioning (HVAC) system.

3. The vehicle user preference system as recited in claim 1 wherein said mobile device is a smartphone.

4. The vehicle user preference system as recited in claim 1 further comprising a subsystem interface through which said processor is configured to distribute settings based on said user preferences to said vehicle subsystems.

5. The vehicle user preference system as recited in claim 1 wherein said memory is configured to store multiple user preference data structures associated with respective DIPs corresponding to respective mobile devices.

6. The vehicle user preference system as recited in claim 1 wherein said mobile device and said DIP are operable to identify a passenger.

7. The vehicle user preference system as recited in claim 1 further comprising a driver detection module configured to distinguish said mobile device from another mobile device operable to identify a passenger.

8. The vehicle user preference system as recited in claim 1 wherein said communication interface includes a universal serial bus (USB) interface.

9. A method of applying user preferences to a vehicle, comprising:
receiving a device ID profile (DIP) indicative that a particular user is present;
employing said DIP to gain access to user preferences associated with said particular user; and
causing said user preferences to be applied to vehicle subsystems.

10. The method as recited in claim 9 further comprising establishing a Bluetooth connection with a mobile device corresponding to said DIP and said particular user.

11. The method as recited in claim 10 further comprising selecting a mobile device classification from the group consisting of driver device and passenger device.

12. The method as recited in claim 9 wherein said causing includes generating positional commands for a power seat system.

13. The method as recited in claim 9 wherein said causing includes transmitting subsystem settings based on said user preferences toward a central vehicle computer, from which said subsystem settings are distributed.

14. The method as recited in claim 9 wherein said vehicle subsystems include a navigation system and audio system.

15. The method as recited in claim 9 wherein said causing initiates upon powering-on said vehicle.

16. An automobile computer system, comprising:
a memory configured to store a plurality of user preference data structures, according to which respective user preferences for a plurality of users are stored;
a Bluetooth subsystem operable to detect and pair with a mobile device having a device ID profile (DIP) associated with a particular user preference data structure of said plurality of user preference data structures;
a processor communicably coupled to said Bluetooth subsystem and said memory, and operable to gain access to and employ said DIP to gain access to said particular user preference data structure; and
a subsystem interface communicably coupled to said processor and configured to apply said respective user preferences contained in said particular user preference data structure to a plurality of vehicle subsystems in an automobile.

17. The automobile computer system as recited in claim 16 further comprising a driver detection module communicably coupled to said Bluetooth subsystem and operable to compute the location of said mobile device with respect to a driver's seat.

18. The automobile computer system as recited in claim 16 wherein said user settings interface is operable to extract user settings from said plurality of vehicle subsystems for transmission to said processor.

19. The automobile computer system as recited in claim 18 wherein said processor is further operable to write said user settings to said memory in said particular user preference data structure.

20. The automobile computer system as recited in claim 16 wherein said Bluetooth communication subsystem is configured to initiate a pairing with said mobile device upon unlocking said automobile.

21. The automobile computer system as recited in claim 16 wherein said respective user preferences includes seat and mirror positions.
